(19) United States
(12) Patent Application Publication
(10) Pub. No.: US 2014/0134717 A1
(43) Pub. Date: May 15, 2014

(54) FLUID TREATMENT APPARATUS AND METHOD

(71) Applicant: Samsung Electronics Co., Ltd., Suwon-si (KR)

(72) Inventors: Hui-sung MOON, Seoul (KR); Tae-seok SIM, Seoul (KR); Jeong-gun LEE, Seoul (KR); Hyo-young JEONG, Seoul (KR); June-young LEE, Anyang-si (KR); Jin-mi OH, Suwon-si (KR)

(21) Appl. No.: 13/970,711

(22) Filed: Aug. 20, 2013

(30) Foreign Application Priority Data
Nov. 15, 2012 (KR) 10-2012-0129785

(51) Int. Cl. G01N 1/34

(52) U.S. Cl. CPC G01N 1/34
USPC 435/309.1

(57) ABSTRACT

A fluid treatment apparatus and method. The fluid treatment apparatus includes a chamber containing a first fluid with a first density and a second fluid with a second density, a channel disposed in the chamber to discharge the first fluid from the chamber, and a valve material disposed in the channel, wherein the valve material controls the discharge of the first fluid from the chamber based upon a phase transition characteristic.

### CROSS-REFERENCE TO RELATED APPLICATIONS

This application claims the benefit of Korean Patent Application No. 10-2012-0129785, filed on Nov. 15, 2012 in the Korean Intellectual Property Office, the disclosure of which is incorporated herein in its entirety by reference.

### BACKGROUND

1. Field

The present disclosure relates to fluid treatment apparatuses and fluid treatment methods using the same.

2. Description of the Related Art

Methods of extracting certain components, such as white blood cells, from a sample, such as blood, may be classified as methods of removing unnecessary components from the sample through a chemical treatment so as to have only a necessary component remain. These methods may also be classified as methods of dividing the sample through centrifugation into fluids in a plurality of layers according to a characteristic of the fluids, and separating and extracting a certain layer with a certain characteristic from the plurality of fluid layers.

In general, it is relatively easy to extract an upper layer fluid from the plurality of fluid layers. For example, a tube may be inserted from above to extract an uppermost layer from among the plurality of fluid layers. However, if the tube is inserted from above in order to extract a lower layer fluid or an intermediate layer fluid, the fluid may be damaged, lost, or contaminated.

In particular, if cells that are rare in blood, for example, circulating tumor cells or nucleated red blood cells (NRBCs), are extracted through a centrifugation process, these cells are located between plasma located at an upper layer and red blood cells located at a lower layer. Therefore, a method is desired for extracting a fine amount of cells without loss.

### SUMMARY

Provided are fluid treatment apparatuses and methods capable of removing fluid located at one layer from among fluids located at a plurality of layers. Additional aspects will be set forth in the description which follows and will be apparent from the description, or may be learned by practice of the presented embodiments.

According to an aspect of the present invention, a fluid treatment apparatus includes: a chamber containing a first fluid with a first density and a second fluid with a second density; a channel disposed in the chamber to discharge the first fluid from the chamber; and a valve material disposed in the channel, wherein the valve material controls the discharge of the first fluid from the chamber based upon a phase transition characteristic.

The valve material may undergo a phase transition when heat is applied, and the valve material may be moved upon application of a pressure to either the chamber or the channel. The valve material may comprise a phase transition material that is in a solid state at a predetermined temperature and transitions to a liquid state at a temperature above the predetermined temperature. The phase transition material may include at least one of a wax, a gel, and a thermosetting resin. The valve material may include heat generating particles that absorb light to generate heat. The heat generating particles may be formed of a metal oxide material. The light may be light produced by a laser.

The chamber may have a tubular shape with a first end and a second end, wherein the first end is open. The chamber may include a first region with a hollow cylindrical shape and a second region with a hollow conical shape, the second region being closed at one end.

The channel may be disposed on an inner wall of the chamber. A first end portion of the channel may be disposed to contact the first fluid, and the second end portion of the channel may be disposed outside of the chamber. A cross-sectional area of the channel may be less than a cross-sectional area of the chamber. The first fluid may contain particles, each particle with a largest cross-sectional dimension that is smaller than the smallest cross-sectional dimension of the channel. The valve material may be disposed in a region of the channel so as to contact the first fluid.

The first fluid may be discharged from the chamber through the channel upon application of a positive pressure to the chamber. The first fluid may be discharged from the chamber through the channel upon application of a negative pressure to the channel.

According to another aspect of the present invention, a fluid treatment method includes: dividing a sample into at least a first fluid layer and a second fluid layer, the first fluid having a density greater than the second fluid, and controlling movement of the first fluid layer by using by using a valve material having a phase transition characteristic.

The valve material may include a phase transition material that is in a solid state at a predetermined temperature and transitions to a liquid state at a temperature above the predetermined temperature. The valve material may include heat generating particles that absorb light to generate heat. The sample may be divided into at least the first fluid layer and the second fluid layer by a centrifugation process. The sample may include at least one of whole blood, sputum, urine, and saliva.

### BRIEF DESCRIPTION OF THE DRAWINGS

These and/or other aspects will become apparent and more readily appreciated from the following description of the embodiments, taken in conjunction with the accompanying drawings, of which:

FIG. 1 is a cross-sectional view of a fluid treatment apparatus according to an embodiment of the present invention; and

FIGS. 2A through 2E illustrate fluids divided into a plurality of layers using the fluid treatment apparatus of FIG. 1.

FIG. 3 illustrates an alternative embodiment of a fluid treatment apparatus; and

FIG. 4 illustrates another alternative embodiment of a fluid treatment apparatus.

### DETAILED DESCRIPTION

Hereinafter, a fluid treatment apparatus 100 and a fluid treatment method using the apparatus 100 will be described in detail. Expressions such as “at least one of,” when preceding a list of elements, modify the entire list of elements and do not modify the individual elements of the list.

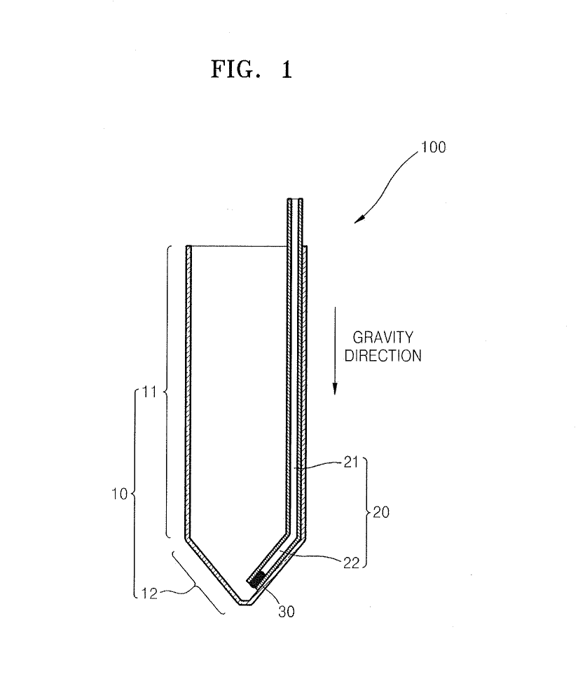

FIG. 1 is a cross-sectional view of the fluid treatment apparatus 100 according to an embodiment. As shown in FIG. 1, the fluid treatment apparatus 100 includes a chamber 10, a channel 20 disposed in the chamber 10, and a valve material 30 disposed in the channel 20.

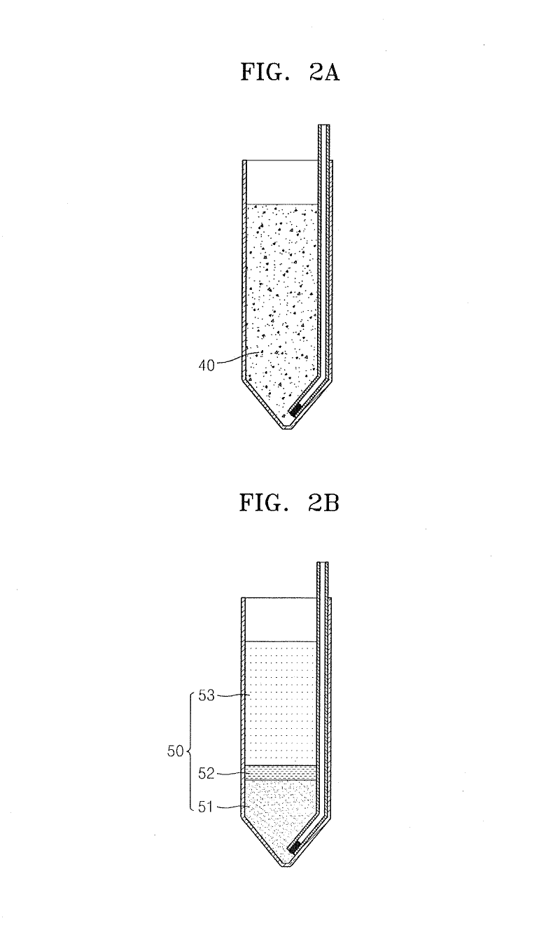

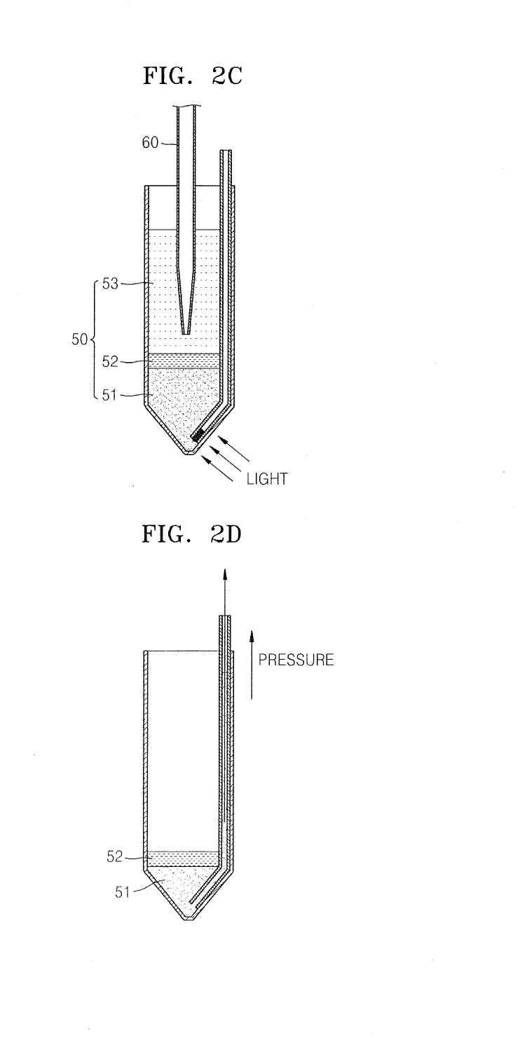

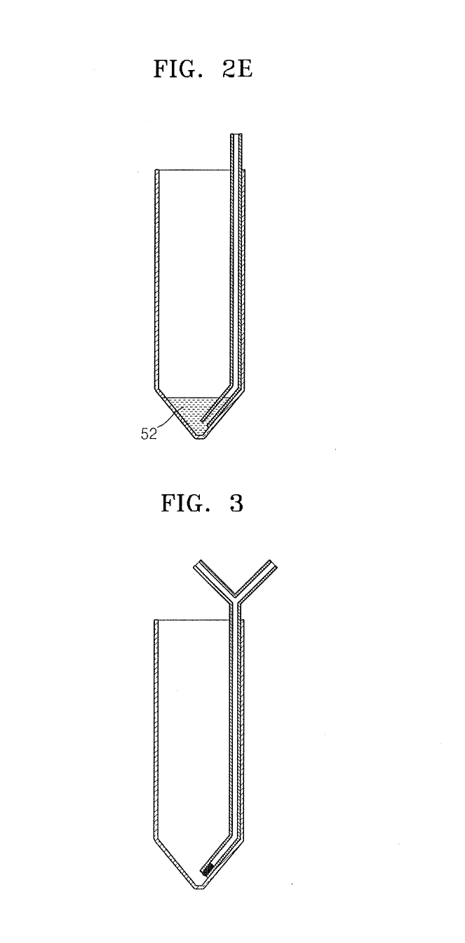

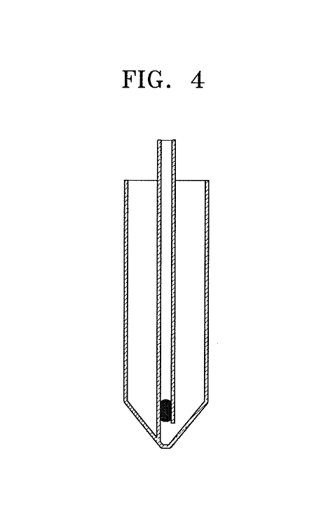

The chamber 10 may include a space for containing a sample 40 (as shown in FIG. 2A) or fluid therein. The chamber 10 may be a tubular shape with a first upper portion and a second lower portion. When the chamber 10 is upright with respect to a gravity direction, the first upper portion of the chamber 10 may be open and the second lower portion of the chamber 10 may be closed. The upper portion of the chamber 10 may be referred to as an opening. The chamber 10 may be divided into a first region 11 having a constant cross-section and a second region 12 having a cross-section that narrows in a downward direction so as to form a closed end of the chamber 10. The first region 11 may have a hollow cylinder shape and the second region 12 may have a hollow conical shape. The narrower cross-sectional area at the lower portion of the second region 12 facilitates removal through the channel 20 of the fluid disposed at the lower portion of the chamber 10, such as the fluid in first layer 51 (as shown in FIG. 2B).

Chamber 10 may be formed of a transparent material so as permit identification of the sample 40 or the fluid. For example, chamber 10 may be formed of a glass material or a transparent plastic material. More specifically, chamber 10 may be formed of a polymer material such as polypropylene, polyethylene, thermoplastic elastomer (TPE), elastic polymer, fluoro polymer, poly methyl methacrylate (PMMA), high impact polystyrene (HIPS), or high impact poly methyl methacrylate (HIPPMMA).

Channel 20 is disposed in the chamber 10. Fluid may flow from chamber 10 through channel 20. Valve material 30 located in channel 20 controls the discharge of the fluid, such as the fluid from first layer 51 (as shown in FIG. 2B), from chamber 10 by using a phase transition characteristic. The cross-sectional area of channel 20 is less than that of the chamber 10. The fluid may contain particles with cross-sectional dimensions. The largest cross-sectional dimensions of the particles are smaller than the smallest cross-sectional dimension of the channel 20 so that channel 20 does not restrict the discharge of the fluid through channel 20. The channel 20 may be formed as a small tube. Opposite ends of the channel 20 may be open so that the fluid in the chamber 10 may pass through channel 20 and be discharged from chamber 10. For example, an end of the channel 20 may be open at the lower portion of the chamber 10 and the other end of the channel 20 may be open to the outside of chamber 10. In the fluid treatment apparatus 100 of the present embodiment, an end of the channel 20 may be an inlet of the fluid and the other end of the channel 20 may be an outlet of the fluid for discharging the fluid from the chamber 10.

The above described channel 20 has a shape corresponding to that of the chamber 10 so that the channel 20 may be integrally disposed at a side wall of the chamber 10. For example, the channel 20 may be classified as a third region 21 contacting the first region 11 of the chamber 10 and a fourth region 22 contacting the second region 12 of the chamber 10. The channel 20 may be formed of glass, a transparent plastic material, or any material from which chamber 10 may be formed.

Valve material 30 is disposed in the channel 20 and may either block the fluid or permit the flow of the fluid. The valve material 30 may, for example, be disposed in the fourth region 22 of the channel 20. The valve material 30 may be disposed in the channel 20 so as to contact the fluid to be removed via the channel 20 when the fluid has not yet entered channel 20 from chamber 10.

The valve material 30 may include a phase transition material, wherein the valve material undergoes a phase transition when the temperature rises above a predetermined temperature. For example, the phase transition material may be in a solid state at a predetermined temperature, such as a room temperature, and may transition to a liquid state once the temperature rises above the predetermined temperature. The phase transition material may be wax. When the temperature of the wax rises above a predetermined temperature, the wax transitions to a liquid state and a volume of the wax increases. The wax may be, for example, paraffin wax, microcrystalline wax, synthetic wax, or natural wax. The phase transition material may also be a gel or a thermosetting resin. The gel may be polyacrylamide, polyacrylates, polymethacrylates, or polyvinylamides. The thermosetting resin may be COC, PMMA, PC, PS, POM, PFA, PVC, PP, PET, PEEK, PA, PSU, or PVDF.

The valve material 30 may include heat generating particles that absorb light to generate heat. The heat generating particles may have a largest cross-sectional dimension that is smaller than a smallest cross-sectional dimension of the channel 20 so as to capable of being freely transmitted through the channel 20 when the valve material 30 is in a liquid state. When energy, such as laser irradiation, is supplied to the heat generating particles, a temperature of the heat generating particles rapidly rises and the particles generate heat. The heat generating particles having the above property may have a core including a metal component and a hydrophobic surface structure. For example, the heat generating particle may have a molecular structure including a core formed of iron (Fe) and a plurality of surfactants coupled to the iron molecule to surround the iron core. The heat generating particle is not limited to the above described polymer type, but may be formed as a quantum dot or a magnetic bead. In addition, the heat generating particle may include a ferromagnetic component such as Fe, Ni, Co, or an oxide thereof, or may include a metal oxide such as Al₂O₃, TiO₂, Ta₂O₃, Fe₂O₃, Fe₃O₄, or HfO₂.

Because the phase transition material of valve material 30 is in a solid state at predetermined temperature, the valve material 30 is hardened at the predetermined temperature. Valve material 30 may be located at an end portion of the fourth region 22 of the channel 20. When light produced by a laser irradiates the valve material 30, the valve material 30 transitions from a solid state, expands, and moves into the channel 20. In addition, when the light irradiation stops, the valve material 30 in the channel 20 hardens, again blocking an inner space of the channel 20. As described above, the channel 20, in which valve material 30 is located, is disposed on an inner wall of the chamber 10.

FIGS. 2A through 2E illustrate a method of separating the fluid divided into a plurality of layers by using the fluid treatment apparatus 100 of FIG. 1. As shown in FIG. 2A, the sample 40 is injected, or otherwise introduced, into the chamber 10. The sample 40 may include at least one of whole blood, sputum, urine, and saliva. In addition, the sample 40 included in the chamber 10 is divided through a centrifugation process into fluids of a plurality of layers. If the sample 40 is whole blood, a reagent, such as a density gradient medium (DGM), is injected, or otherwise introduced, into the chamber 10 with the sample 40, and a blood diluent, in which whole blood is mixed with salt water and an anticoagulant, is injected, or otherwise introduced, into the chamber 10 to be deposited on the reagent.

The chamber 10 is then placed into a separation apparatus such as an apparatus containing a rotating disc platform, and the separation apparatus is rotated. The rotation of the separation apparatus causes a centrifugal force to be applied to chamber 10, dividing sample 40 into fluids of a plurality of layers of different densities.

For example, if the sample 40 is blood, as shown in FIG. 2B, the sample 40 is divided into three fluid layers of different densities. First, second, and third layers 51, 52, and 53 are sequentially formed in a lower portion of the chamber 10. The first layer 51 is a dark red liquid containing red blood cells (RBCs), and has the greatest relative density of all the fluid layers. The second layer 52 is a colorless liquid containing white blood cells (WBCs), has a density that is less than that of the first layer 51, and is the component to be extracted from the sample. The third layer 53 is a light red liquid containing relatively few RBCs and WBCs, and has the lowest density of all three layers.

As shown in FIG. 2B, the sample 40 is divided into a plurality of layers according to relative density. As shown in FIG. 2C, the third layer 53 may be removed by using a pipette 60. When a pressure within the pipette 60 decreases, the third layer 53 is drawn into the pipette 60 and removed from the chamber 10.

After removing the third layer 53, light irradiates a region where the valve material 30 is located. The light may be electromagnetic waves or laser light. When the light irradiates the valve material 30, the heat generating particles absorb the light and generate heat, and the heat is transferred to the phase transition material. The heat causes the phase transition material of valve material 30 to transition to a liquid phase.

When a negative pressure (i.e., a pressure less than an atmospheric pressure) is applied to the channel 20 when the valve material 30 is in the liquid phase, the valve material 30 moves through channel 20 and is discharged through an outlet, opening channel 20. When the negative pressure is continuously applied, as shown in FIG. 2D, the first layer 51 is discharged from chamber 10 through channel 20. When the discharge of the first layer 51 is complete, the negative pressure is removed from channel 20. As shown in FIG. 2E, only the second layer 52 remains within the chamber 10 and channel 20.

The separation of the fluid into layers permits the efficient removal of the densest fluid layer through the use of the valve material 30 and channel 20. This method minimizes the damage to the remaining layers, which may be extracted for further analysis.

In the present embodiment, the sample 40 is divided into a plurality of fluid layers by a centrifugation process, but other methods may be used to separate the fluids into the plurality of layers. For example, the sample 40 may be divided into the plurality of layers through a chemical treatment, and the fluid treatment apparatus 100 may then be used to remove the fluid located at the lower layer.

In the present embodiment, the fluid at the lower layer is removed through the application of a negative pressure to the channel. However, other methods may be used to remove the fluid at the lower layer. For example, the fluid at the lower layer may be removed by using a positive pressure or a centrifugal force. If a center of the channel 20 of the fluid treatment apparatus 100 is located farther from a rotary shaft than a center of the chamber 10, and centrifugal force is applied to the fluid treatment apparatus 100, the fluid in the channel 20 will move toward a lower portion of the channel 20 due to the centrifugal force, and the valve material 30 and the fluid at the lower layer may be removed through the channel 20. Also, when the positive pressure is applied to the chamber 10 via the opening of the chamber 10, the fluid of the upper layer pushes the fluid at the lower layer due to the positive pressure, and accordingly, the fluid at the lower layer may be discharged from chamber 10 through channel 20.

In FIGS. 2A through 2E, the sample 40 is divided into fluids of three layers; however, the present invention is not limited thereto. The fluid treatment apparatus 100 may be used to remove the fluid at the lower layer when the sample 40 is divided into two or more layers.

In the present embodiment, the fluid in chamber 10 is discharged from chamber 10 through channel 20; however, the present invention is not limited thereto. That is, after removing the valve material 30 from the channel 20, another fluid may be introduced to chamber 10.

According to the fluid treatment apparatus of the present invention, the location of the valve material at a lower end portion of the chamber prevents leakage of the fluid into the channel. The valve material may be removed from the channel using pressure and heat, and thus, loss of the fluid may be prevented.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fluid treatment apparatus comprising:
a chamber containing a first fluid with a first density and a second fluid with a second density;
a channel disposed in the chamber to discharge the first fluid from the chamber; and
a valve material disposed in the channel, wherein the valve material controls the discharge of the first fluid from the chamber based upon a phase transition characteristic.

2. The fluid treatment apparatus of claim 1, wherein the valve material undergoes a phase transition when heat is applied, and the valve material moves upon application of a pressure to either the chamber or the channel.

3. The fluid treatment apparatus of claim 1, wherein the valve material comprises a phase transition material that is in a solid state at a predetermined temperature and transitions to a liquid state at a temperature above the predetermined temperature.

4. The fluid treatment apparatus of claim 3, wherein the phase transition material comprises at least one of a wax, a gel, and a thermosetting resin.

5. The fluid treatment apparatus of claim 1, wherein the valve material comprises heat generating particles that absorb light to generate heat.

6. The fluid treatment apparatus of claim 5, wherein the heat generating particles comprise a metal oxide material.

7. The fluid treatment apparatus of claim 5, wherein the light is produced by a laser.

8. The fluid treatment apparatus of claim 1, wherein the chamber has a tubular shape with a first upper portion and a second lower portion, and the first upper portion comprises an opening.

9. The fluid treatment apparatus of claim 1, wherein the chamber comprises:
a first region with a hollow cylindrical shape; and
a second region with a hollow conical shape, the second region being closed at one end.

10. The fluid treatment apparatus of claim 1, wherein the channel is disposed on an inner wall of the chamber.

11. The fluid treatment apparatus of claim 1, wherein a first end portion of the channel is disposed to contact the first fluid and a second end portion of the channel is disposed outside of the chamber.

12. The fluid treatment apparatus of claim 1, wherein a cross-sectional area of the channel is less than a cross-sectional area of the chamber, and the first fluid contains particles with largest cross-sectional dimensions smaller than the smallest cross-sectional dimension of the channel.

13. The fluid treatment apparatus of claim 1, wherein the valve material is disposed in a region of the channel so as to contact the first fluid.

14. The fluid treatment apparatus of claim 1, wherein the first fluid is discharged from the chamber through the channel upon application of a positive pressure to the chamber.

15. The fluid treatment apparatus of claim 1, wherein the first fluid is discharged from the chamber through the channel upon application of a negative pressure to the channel.

16. A fluid treatment method comprising:
dividing a sample into at least a first fluid layer and a second fluid layer, the first fluid layer having a density greater than the second fluid layer; and
controlling movement of the first fluid layer using a valve material having a phase transition characteristic.

17. The fluid treatment method of claim 16, wherein the valve material comprises a phase transition material that is in a solid state at a predetermined temperature and transitions to a liquid state at a temperature above the predetermined temperature.

18. The fluid treatment method of claim 16, wherein the valve material comprises heat generating particles that absorb light to generate heat.

19. The fluid treatment method of claim 16, wherein the sample is divided into at least the first fluid layer and the second fluid layer by a centrifugation process.

20. The fluid treatment method of claim 16, wherein the sample comprises at least one of whole blood, sputum, urine, and saliva.
